(19) United States
(12) Patent Application Publication
(10) Pub. No.: US 2019/0322902 A1
(43) Pub. Date: Oct. 24, 2019

(54) ADHESIVE SHEETS FOR ABUTTING THE PERIPHERY OF ANGULARLY SHAPED CONDUITS

(71) Applicant: Alford M. Quinland, Bronx, NY (US)

(72) Inventor: Alford M. Quinland, Bronx, NY (US)

(21) Appl. No.: 15/959,585

(22) Filed: Apr. 23, 2018

(51) Int. Cl. C09J 7/10; C09J 7/40

(52) U.S. Cl. CPC C09J 7/10; C09J 7/40

(57) ABSTRACT

Adhesive sheets adapted and dimensioned to conform to angular shapes along a surface are provided. The adhesive sheets thereby provide clean, crisp edges along the surface from with the angular-shaped conduit protrudes. In the case of a surface surrounding a circular conduit the present invention provides adhesive sheets shaped in a semicircular piece/strip that fits in one piece to snugly circumscribe at least a portion of the circular conduit.

### BACKGROUND OF THE INVENTION

The present invention relates to adhesives and, more particularly, to adhesive sheets dimensioned and adapted to be applied along a supporting surface circumscribing an angularly shaped conduit so that the adhesive sheets abut the periphery of said conduits, completely protecting the surrounding surface from debris and paint.

When painting conduits that extending from or into surrounding surfaces, e.g., pipes that come out of or in to a wall or floor, one would need several pieces from a traditional roll of painter's tape to go around the conduit in order to protect such a surface from the color that the conduit is being painted, assuming the conduit and the surface are to be different colors.

Because painter's tape is flat and straight, essentially merely rectangular, such tape will not fit snugly about conduits (such as pipes, venting, and the like) having angular geometric shapes and configurations. In such “angular conditions” standard roll painter's tape would require multiple pieces of taping as well multiple steps, to rip the rectangular strips piece by piece to go around pipes, resulting in a painstaking and time-consuming process to tape off such surrounding surfaces, yet does not provide crisp clean edges there along because of applying a simple rectangular shape to circular and other angular shapes.

As can be seen, there is a need for adhesive sheets adapted and dimensioned to conform to angular shapes along a surface, thereby providing clean, crisp edges along said surface. In the case of a surface surrounding a circular conduit the present invention provides adhesive sheets shaped in a semicircular piece/strip that fits in one piece to snugly circumscribe the circular conduit, thereby providing crisp clean edges there around. As a result, the present invention saves time while producing crisp clean edges every single time.

### SUMMARY OF THE INVENTION

In one aspect of the present invention, an adhesive sheet may be dimensioned and adapted to be applied along a supporting surface circumscribing an angularly shaped conduit so that the adhesive sheet abuts against a periphery of said angularly shaped conduits, protecting the surrounding surface from debris and paint, including a first surface and an opposing adhesive surface.

In another aspect of the present invention, the adhesive sheet may be dimensioned and adapted to be applied along a supporting surface circumscribing an angularly shaped conduit so that the adhesive sheet abuts against a periphery of said angularly shaped conduits, protecting the surrounding surface from debris and paint, including a first surface providing only one of a rounded-C, a square-D or a square L shape; an opposing adhesive surface; and a peel-away backer removably attached to the adhesive surface.

In yet another aspect of the present invention, a method of protecting from debris a surrounding surface from which an angular shaped conduit protrudes therefrom, includes providing one or more above mentioned adhesive sheets; selecting one of said one or more adhesive sheets having a peripheral edge of said first surface that would abut against a substantial portion of a periphery of said angular shaped conduit; peeling away the peel-away backer of said one of said one or more adhesive sheets; and adhering said adhesive surface to the surrounding surface so that said peripheral edge of said first surface that abuts against said substantial portion of said periphery of said angular shaped conduit.

These and other features, aspects and advantages of the present invention will become better understood with reference to the following drawings, description and claims.

### BRIEF DESCRIPTION OF THE DRAWINGS

FIG. 1 is a perspective view of an exemplary embodiment of the present invention;

FIG. 2 is a top perspective view of an exemplary embodiment of the present invention;

FIG. 3 is a bottom perspective view of an exemplary embodiment of the present invention;

FIG. 4 is a section view of an exemplary embodiment of the present invention, taken along line 4-4 in FIG. 3;

FIG. 5 is a bottom exploded perspective view of an exemplary embodiment of the present invention;

FIG. 6 is a perspective view of an exemplary embodiment of the present invention;

FIG. 7 is a top perspective view of an exemplary embodiment of the present invention;

FIG. 8 is a bottom perspective view of an exemplary embodiment of the present invention;

FIG. 9 is a bottom exploded perspective view of an exemplary embodiment of the present invention;

FIG. 10 is a perspective view of an exemplary embodiment of the present invention;

FIG. 11 is a top perspective view of an exemplary embodiment of the present invention;

FIG. 12 is a bottom perspective view of an exemplary embodiment of the present invention;

FIG. 13 is a bottom exploded perspective view of an exemplary embodiment of the present invention;

FIG. 14 is a perspective view of an exemplary embodiment of the present invention;

FIG. 15 is a top perspective view of an exemplary embodiment of the present invention;

FIG. 16 is a bottom perspective view of an exemplary embodiment of the present invention; and

FIG. 17 is a bottom exploded perspective view of an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides adhesive sheets dimensioned and adapted to be applied along a supporting surface circumscribing an angularly shaped conduit so that the adhesive sheet abuts against the periphery of said conduits, protecting the surrounding surface from debris and paint.

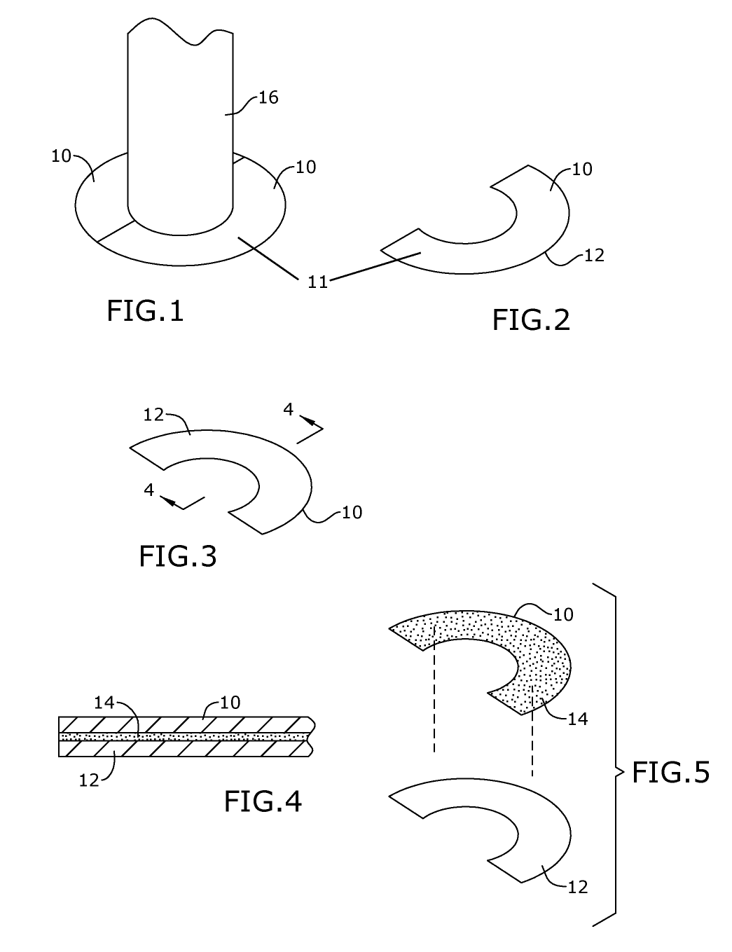

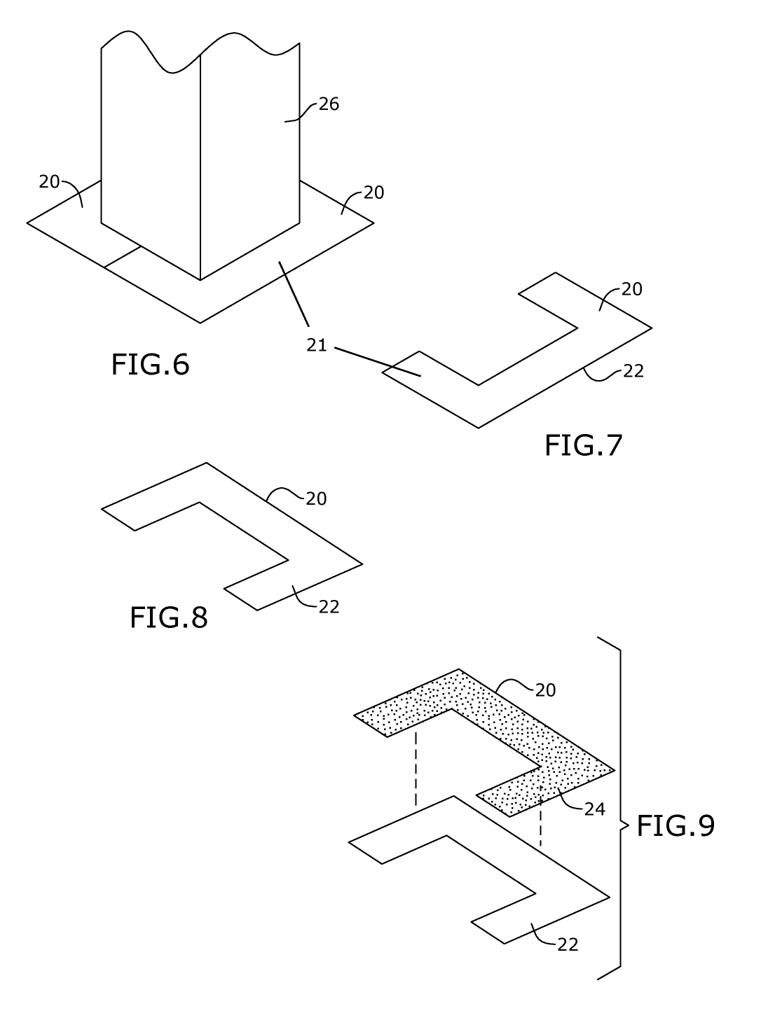

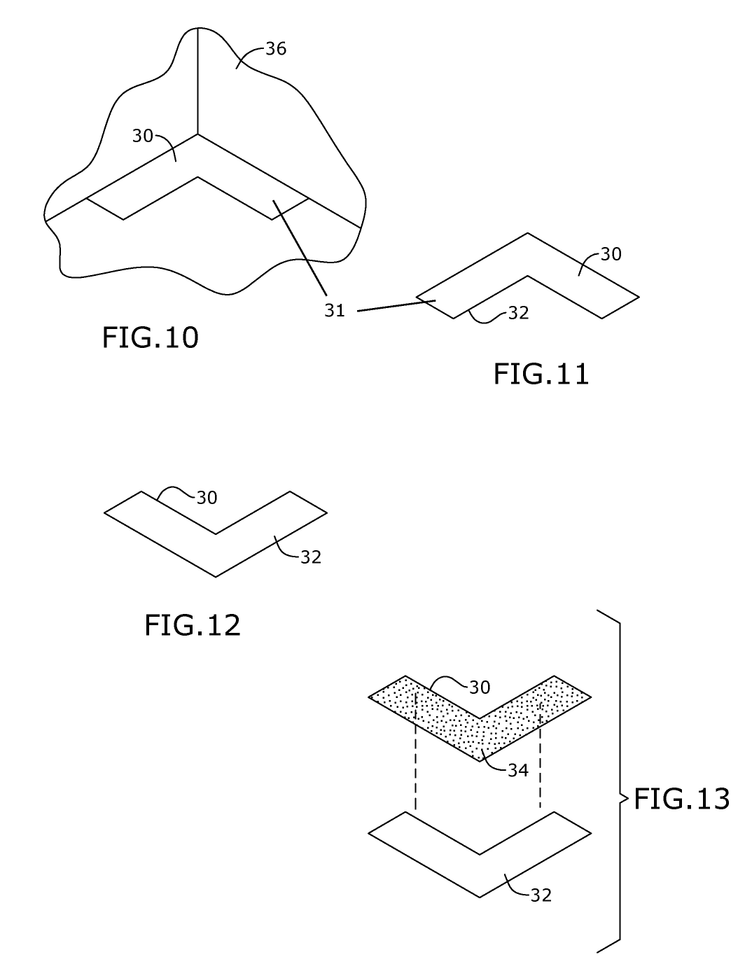

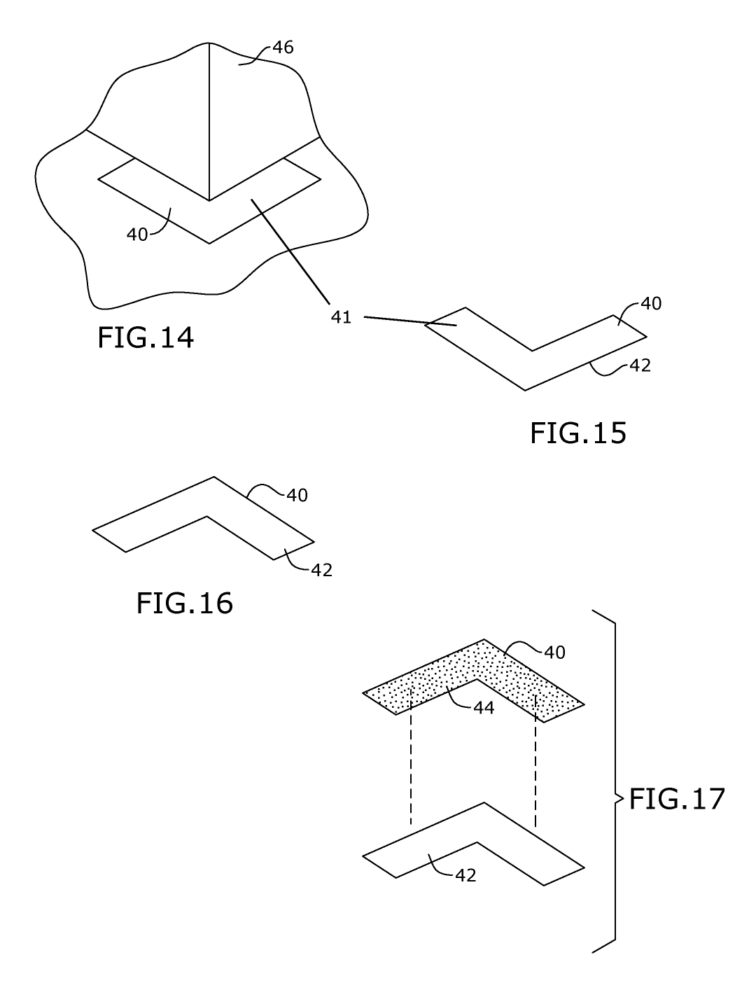

Referring to FIGS. 1 through 17, the present invention may include adhesive sheets 10, 20, 30, 40 that are shaped in a rounded-C shape 10, squared-C shape 20, squared-L shapes 30 and 40, or other geometric shapes shown or not shown in the appended Figures. The difference between the squared-L shape 30 and 40 may be that they are mirror images of each other when viewed relative to their adhesive surface 34 and 44, respectively; the same could apply to alternative embodiments of adhesive sheets 10 and 20.

The adhesive surfaces 14, 24, 34, and 44 of the adhesive sheets 10, 20, 30, and 40, respectively, may be adapted to removably attached a respective adhesive sheet 10, 20, 30, or 40 to a supporting surface, such as a wall or floor. Each adhesive surface 14, 24, 34, or 44 may have a peel-away backer 12, 22, 32, or 42, respectively for preventing that application of the adhesive surface 14, 24, 34, or 44 to any surface until the respective peel-away backer is peeled away. The adhesive surfaces 14, 24, 34, and 44 may have the peel-away backer 12, 22, 32, and 42 have a generally coextensive surface area as that of each other and the overall shape of the respective adhesive sheet 10, 20, 30, or 40. In certain embodiments, the peel-away backer 12, 22, 32, and 42 may be less than coextensive their respective adhesive surfaces 14, 24, 34, and 44. In other words, a plurality of adhesive surfaces are operatively engaged with one peel-away backer, so that a user would selectively peel off one of the plurality of adhesive services at a time for optimally accomplishing the task at hand.

Though in certain embodiments, the adhesive surface 14, 24, 34, and 44 may be proportionally smaller than the respective peel-away backer 12, 22, 32, and 42, which may be proportionally smaller or larger than the respective adhesive sheet 10, 20, 30, or 40.

Each adhesive sheet 10, 20, 30, or 40 has a first surface 11, 21, 31, and 41 opposing the adhesive surfaces 14, 24, 34, and 44. Said first surface 11, 21, 31, and 41 is outward facing during use, as illustrated in the Figures. The first surface 11, 21, 31, and 41 is want protects the supporting surface during use.

A method of using the present invention may include the following. The adhesive sheets 10, 20, 30, and 40 disclosed above may be provided. A user may selectively apply the appropriately shaped adhesive sheets 10, 20, 30, or 40 based on the shape of the conduit 16, 26, 36, or 46 the user is attempting to snugly circumscribe. In other words, the user peels away the applicable peel-away backer 12, 22, 32, or 42 and abuts the appropriate peripheral edge of the adhesive sheet 10, 20, 30, or 40 against the relevant conduit 16, 26, 36, or 46 so that the relevant adhesive surface 14, 24, 34, and 44 removably attached to the supporting surface surrounding said conduit 16, 26, 36, or 46, thereby protecting the supporting surface when painting the conduit 16, 26, 36, or 46.

In the case of a surface surrounding a circular conduit the user applies the semicircular strip of adhesive sheet 10 so that one piece thereof abuts at least a substantial portion of a periphery of the circular conduit. The same approach may apply to other angularly shaped conduits, as illustrate in the Figures.

It should be understood, of course, that the foregoing relates to exemplary embodiments of the invention and that modifications may be made without departing from the spirit and scope of the invention as set forth in the following claims.

What is claimed is:

1. An adhesive sheet dimensioned and adapted to be applied along a supporting surface circumscribing an angularly shaped conduit so that the adhesive sheet abuts against a periphery of said angularly shaped conduits, protecting the surrounding surface from debris and paint, comprising:
a first surface; and
an opposing adhesive surface.

2. The adhesive sheet of claim 1, wherein the first surface provides only a rounded-C shape.

3. The adhesive sheet of claim 1, wherein the first surface provides only a squared-C shape.

4. The adhesive sheet of claim 1, wherein the first surface provides only a squared-L shape.

5. The adhesive sheet of claim 1, further comprising a peel-away backer removably attached to the adhesive surface.

6. The adhesive sheet of claim 5, wherein said peel-away backer is generally coextensive with the respective adhesive surface.

7. The adhesive sheet of claim 5, wherein said peel-away backer is generally coextensive with a plurality of adhesive surfaces, said adhesive surface being one of said plurality of adhesive services.

8. An adhesive sheet dimensioned and adapted to be applied along a supporting surface circumscribing an angularly shaped conduit so that the adhesive sheet abuts against a periphery of said angularly shaped conduits, protecting the surrounding surface from debris and paint, comprising:
a first surface providing only one of a rounded-C, a square-D or a square L shape;
an opposing adhesive surface; and
a peel-away backer removably attached to the adhesive surface.

9. A method of protecting from debris a surrounding surface from which an angular shaped conduit protrudes therefrom, comprising:
providing one or more adhesive sheets of claim 8;
selecting one of said one or more adhesive sheets having a peripheral edge of said first surface that would abut against a substantial portion of a periphery of said angular shaped conduit;
peeling away the peel-away backer of said one of said one or more adhesive sheets; and
adhering said adhesive surface to the surrounding surface so that said peripheral edge of said first surface that abuts against said substantial portion of said periphery of said angular shaped conduit.
